(19) United States
(12) Patent Application Publication
(10) Pub. No.: US 2005/0072398 A1
(43) Pub. Date: Apr. 7, 2005

(54) Positive displacement turbine engine

(76) Inventors: Michael Feinstein, Houston, TX (US); Jay Faulhaber, North Canton, OH (US); Ronald S. Block, Sugar Land, TX (US)

Correspondence Address: Ronald S. Block;Suite 610, 4800 Sugar Grove Blvd., Stafford, TX, 77477, US

(21) Appl. No.: 10/678,792

(22) Filed: Oct. 3, 2003

(51) Int. Cl. F02B 53/00

(52) U.S. Cl. 123/243

(57) ABSTRACT

The “Positive Displacement Turbine” engine (PDT) presented herein conforms to the classical definition of a heat engine. It operates in a thermodynamic cycle approximating the Otto, Diesel and Muller cycles but the primary motive force is developed at the pressure face of a blade rather than at the head of a reciprocating piston. The machine is therefore truly rotary with turbine-like characteristics, nevertheless, a fixed mass of air and fuel is compressed, ignited and expanded in a truly positive displacement process. Improvements offered by the present invention arise from the novel application of compression and expansion cycles being executed in adjacent and isolated chambers dynamically linked via internally mounted rotating combustion chambers hither too unseen as prior art. The means provided by this unique aspect of the present invention place it into a class of prime mover all of its own.

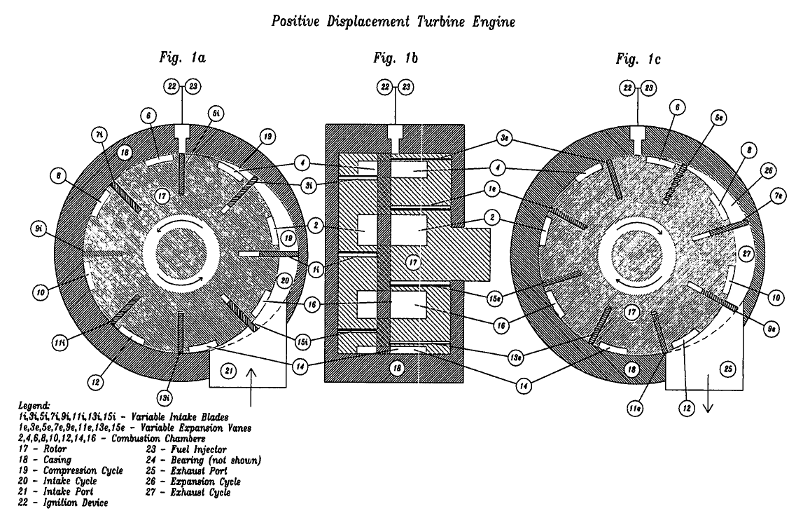

### REFERENCES CITED

U.S. Pat. Nos.:

| | | |
|---|---|---|
| Hapkins | 1,922,363 | 1933 |
| Wankel | 3,688,749 | 1972 |
| Bentley | 3,762,375 | 1973 |
| Stenberg | 3,865,085 | 1975 |
| Umeda | 4,422,419 | 1983 |
| McCann | 5,415,141 | 1995 |
| Holdampf | 5,711,268 | 1998 |
| Miniere | 6,070,565 | 2000 |

### BACKGROUND OF THE INVENTION

To the unassuming observer the notion of a ‘Positive Displacement Turbine Engine’ (PDT) might just be not easy to envision, given that we are used to applying these words to two separate and entirely unrelated thermodynamic power producing processes. We usually refer to the reciprocating automobile engine as a positive displacement device because it entraps a fixed mass of air and fuel in its cylinders before developing torque at the shaft. The turbine, on the other hand, develops torque from the momentum change and reaction to an often expanding but nevertheless steady flowing fluid. The reciprocating motion of a piston is fundamentally different from continuous rotary motion of the turbine blade and yet, the PDT engine, as presented herein, embodies both principals.

A PDT engine offers major improvements in mechanical, volumetric, combustion and overall thermal efficiency. First order and higher order crank shaft dynamic out of balance forces are significantly reduced by the inherently vibration free operation of this rotary machine. The internally mounted combustion chambers offer flexibility in burned to unburned gas ratio. The tendency for misfire is also reduced. The engine described here is less sensitive to many of the operating variables, which affect conventional internal combustion engines such as fuel quality and ignition timing. Combustion emissions species are also more easily dealt with by virtue of the options for isolated or delayed combustion.

Many of the improvements offered by the present invention arise from the novel application of compression and expansion cycles being executed in adjacent and isolated chambers dynamically linked via internally mounted rotating combustion chambers hither too unseen as prior art. The means provided by this unique aspect of the present invention place it into a class of prime mover all of its own.

In the proposed PDT intake air is entrained and compressed into internally mounted combustion chamber(s) by a rotor and one of the positive displacement blades mounted in the rotor. Successive compressions of charge air are constrained between these combustion chambers. The active combustion chamber is isolated and fuel is injected. Ignition and combustion are then initiated, causing the pressure in the active chamber to rise sharply. The products of combustion are constrained to reenter the rotor/blade system and expand behind the active blade. The pressure force on this rear face provides the motive torque to the rotors shaft. Some of the work output created by this torque is transmitted across the rotor to the another blade which now begins its compression ‘stroke’ or sweep in an identical process. Compression and expansion therefore occur within the swept volumes bounded by the outer casing. The four chambers prescribed by the boundaries of the cylinder/blade/rotor/outer case system are sealed at each end of the output shaft by closely toleranced gas seals incorporating both rotating and static elements. Without difficulty it can be seen that multiple expansion power strokes are therefore achieved with each rotation of the shaft.

Classically, in reference to the established reciprocating internal combustion engine, this invention can execute a complete constant volume or constant pressure thermodynamic cycle.

Multiple cylinder chambers can be positioned along one single shaft arrangement. The total number of individual cylinder chambers is limited only by practical consideration of end bearing support design and rotor dynamics.

From the description just given, it should be clear, that the PDT is truly unique in that all the advantages of the conventional four stroke engine are immediately apparent with very few of the disadvantages. A further magnificent bonus occurs because this is truly a rotary machine with turbine-like characteristics. The engine will be responsive and deliver a high torque at low RPM mostly desirable as a vehicle power plant yet it does not require primary balancing weights to offset accelerating piston moment forces about the crankshaft.

Consequently, there are fewer moving parts and its power to weight ratio is therefore inherently good. This is more typical of a lightweight turbine technology. Yet, unlike in small gas turbines, effective compression ratio of the PDT is very much higher, while tip leakage inefficiencies and aerodynamic losses are significantly reduced.

The positive displacement element to the operating cycle permits many variations of the cycle described here to take advantage of double and triple expansion process, i.e. to contain emissions of the working cycle with a succession of rotors cylinder cavities and to permit more work to be extracted from the exhaust gases.

The gas turbine achieves higher efficiency by having a larger numbers of expansion stages. This is expensive and requires extensive machining of delicate components. These improvements are achieved much more simply here in the Positive Displacement Turbine Engine.

Finally, the combustion process utilized by the PDT is quite different from the gas turbine or reciprocating engine. These are ether constant pressure or mixed constant pressure and constant volume processes. The PDT employs active constant volume combustion chambers. The chambers fire sequentially and are dedicated to the leading blade(s) compression cycle(s). The timing of fuel admission, duration of admission and ignition are uniquely more flexible with the machine arrangement. Consequently the ability to optimize the combustion cycle for low exhaust emissions is considerably enhanced and expected to be a major bonus from this invention.

The following section briefly outlines some of the limitations inherent in the design of conventional spark ignition (SI) and compression ignition (CI) engines and sets out to explain how some of these deficiencies are avoided by the present invention.

The usefulness of a prime mover can be measured in many ways but it is usual to place fuel efficiency high on the list. The fuel efficiency of a machine will be determined by its thermodynamic design and the incumbent losses associated with transforming the ideal cycle into a practical working device. The thermodynamic design of a machine is very much fixed by the physical principals, which define its operating cycle. All positive displacement prime movers share a common set of thermodynamic principles (or laws), which restrict the maximum power and efficiency they can achieve. The losses associated with the design of a particular device can however vary considerably from one design to the next. One of significant improvements offered by the present invention arise from a reduction in mechanical losses. Other irreversibilitis to the ideal cycle such as thermal losses, fluid entropic losses and gas leakage etc. are also expected to be trimmed down.

The total mechanical losses in an engine can be presented as the sum of piston/ring assembly frictional losses, camshaft and valving friction losses, compression and throttling work losses, crank shaft and auxiliary losses. Frictional losses increase with RPM and at full speed can reach 25% of the total losses or more. Approximately 50% of the friction loss emanates from the piston/ring and cylinder interface. Another source of mechanical loss, which is unique to the reciprocating engine, is an unavoidable consequence of combustion dynamics. During the process of ignition and combustion very high pressure is spontaneously developed on the top of the piston. Due to the length of time required to complete combustion the ignition point is usually advanced from Top Dead Center causing a additional retarding force to develop which acts against the upward movement of the piston, therefore reducing fuel efficiency and maximum possible power output.

The number of moving parts in modem piston engines is quite large. This increases the complexity of repairs and reduces the life expectancy of the engine. The positive displacement turbine invention described here, by virtue of fewer moving parts, lower internal friction and isolated combustion chambers will incur much lower overall mechanical loses then a conventional reciprocating arrangement.

An important parameter, which affects the thermodynamic performance of the reciprocating engine, is volumetric efficiency. In order to improve volumetric efficiency in the modern reciprocating engine complex valving and air delivery systems have bean developed. Within the last 50 years progress has been made, but volumetric efficiency still remains quite low, typically 75 to 85 percent in very advanced SI engines. The compression ignition or diesel cycle engine demonstrates somewhat better volumetric efficiency due to the absence of any throttling mechanism in the inlet air passages. Because air is normally induced into the cylinder by suction, any restriction in the air passage will reduce the amount of air a cylinder can receive. Inlet restrictions in modern IC engines are typically found at the air filter, intake manifolds and inlet valves. None of these constrictions occur in the presented invention.

Traditional piston engines require complex, timing dependent, ignition and fuel injection systems. Any deviation from design conditions in spark or fuel delivery will reduce fuel efficiency and effective power output. To maintain these parameters at their optimum setting, periodical tune-ups must be performed.

Setting ignition and fuel injection timing requires the attention of qualified technician, which leaves room for human error. For example, a +/−6 degrees ignition point deviation from the base line will decrease the fuel efficiency by 14% to 20% and +/−0.02 in. closing in spark-plug gap will result in a 20% to 25% decline in fuel efficiency.

The proposed engine is free of these problems. Timing of fuel delivery and spark energizing is not critical because combustion takes place within rotating assembly. For the same reason the proposed engine is tolerant to abnormal combustion, i.e., very rapid flame front propagation and sudden increases in pressure, which in the conventional piston engine results in accelerated wear.

The presence of a hydrocarbon-based lubricant in the combustion chamber during combustion increases the level of pollutants in the exhaust gases of conventional reciprocating engines. This problem is significantly reduced in the proposed engine due to the lubricant free combustion chambers and clearance. In the proposed engine the oil used to lubricate moving parts will be able to retain its lubricating qualities for much longer period of time because contact with combustion products is very much reduced.

### THEORY OF OPERATION OF A POSITIVE DISPLACEMENT TURBINE ENGINE

FIGS. (1a,1b,1c) are a simplified outlines showing end/top/end elevation cross sections of the rotor/blade/casing system. It is showing the state of flow and the geometric relationship of the combustion chambers to the rotor (17)/blades assembly and outer case (18). Rotation is counter-clockwise starting in the Intake quadrant (20), blade (3i) compresses a charge of air by virtue of the decreasing volume (19) swept out between the blade (3i) and outer case (18), the compressed air is allowed to enter combustion chamber (4). As blade (3i) rotates through nearly 180 degrees a new charge of air is entrained behind it through the inlet port (21).

In this basically tuned case a stoichiometric mass of fuel is next injected into combustion chamber (4) through injector (23) where upon either spark ignition, compression ignition or torch ignition is affected via ignitor element (22). FIG. (1a). Combustion occurs at constant volume.

As blade (3i) passes through top dead center, combustion chamber (4) timed to open applying high pressure to the upper seal face of the blade (3e) via combustion products. FIGS. (1a,1b). With the flow path open between combustion chamber (4) and the Expansion quadrant (26), combustion products are free to expand fully and isentropically behind the back face of the blade (3e) applying a torque to the rotor. This torque will result from the high differential pressure across blade (3e) and the moment of the resulting force about the rotor center. The high differential pressure occurs because the combustion gasses now presented to the leading face of blade (3e) are the residue of the previous expansion (power) stroke and are therefore almost at the low exhaust manifold pressure. The power stroke continues until blade (3e) reaches exhaust port opening (25). During this stroke the leading face of blade (3e) sweeps out the entire volume of previously expanded gasses that exit the engine casing (18) through the permanently open exhaust manifold (25). Also during this power stroke by the action of the net positive torque on the shaft blade (1i) will have executed a further compression of the charge air into combustion chamber (2). FIGS. (1a,1b). The cycle is now ready to repeat itself except the active combustion chamber is now to be (2). The second power stroke is now executed following fuel injection (23) and ignition (22) in combustion chamber (2). Opening flow path allows a second charge of combustion products to expand behind the back face of blade (1e). FIGS. (1b,1c). The resulting net positive torque drives the rotor (17) and provides the motive force to compress the next charge of air in front of following blades. In any one 360 degrees rotation the machine will therefore execute:

1. Number of compression strokes equivalent to number of blades employed by this particular engine configuration.

2. Number of constant volume combustion reactions equal to the number of compression strokes executed by this particular engine.

3. Number of power strokes equal to the number of combustion reactions produced by this particular engine.

4. Number of exhaust blow down and purge strokes equal to the number of combustion reactions.

5. An equal number of charge air entrainment strokes.

At any instant in time the action of the rotating blades and outer case creates at least four chambers within the casing where compression, expansion, blow down/purge and charge air entrainment are all occurring at the same time around the central axis of the rotor.

1. A Positive Displacement Turbine engine incorporating a bladed rotor revolving within a casing enfolding adjacent and isolated intake/compression and expansion/exhaust chambers and by virtue of these features is acquiring compression force and applying power output at entirely different locations along the common shaft.

2. A Positive Displacement Turbine engine as described in claim 1 incorporating adjacent and isolated intake/compression and expansion/exhaust chambers developing compression and expansion processes by virtue of closely toleranced rotor and outer casing, and these required to continue formidably bounded for the duration of compression sweep or further in the expansion/exhaust section and for the duration of expansion sweep or further in the intake/compression section.

3. A Positive Displacement Turbine engine as described in claims 1,2 incorporating adjacent and isolated intake/compression and expansion/exhaust chambers employing internally mounted rotating combustion chamber(s) carrying out compressed air accumulation, combustion products generation and discharge into a single or multiple chambers where expansion results in an applied torque to the blade/rotor system, which in turn develops power output.

4. A Positive Displacement Turbine engine as described in 1,2,3 having the means to incorporate compression/combustion/expansion chamber elements of different displacement (or total swept volume) symmetrically along a common shaft system, such that advantage can be taken of variable compression to expansion volume ratio, i.e., the swept volume of compression need not be the same as the swept volume of expansion, as has to be the case in the reciprocating engine, since adjacent chambers can now be segregated by design to perform either all compression and/or all expansion at respective locations in axial and/or radial planes of symmetry along the common shaft.

5. A Positive Displacement Turbine engine as described in claims 1,2,3,4 incorporating multiple internally mounted combustion chambers distributed along the rotor such that a multiple distribution of rotor blades and accompanying outer casing(s) a multi-chamber arrangement of varying volume are formed and can be individually tuned to provide either constant volume or constant pressure cycle achieved by further admission of fuel.

6. A Positive Displacement Turbine engine as described in 1,2,3,4,5 incorporating variable blades constrained from making contact with, but closely following the casing profile, forming a ‘leaky’ gas seal with the dividing boundaries at each end of the blades as well as with their tips at the casing inner diameter and therefore permitting blade evading gas to be employed once more in the subsequent expansion and/or compression chamber(s) consequently increasing power output as well as volumetric and overall thermal efficiency.
